(19) United States
(12) Patent Application Publication
(10) Pub. No.: US 2014/0164059 A1
(43) Pub. Date: Jun. 12, 2014

(54) Heuristics to Quantify Data Quality

(71) Applicant: MICROSOFT CORPORATION, (US)

(72) Inventors: Bryan Jason Dove, Seattle, WA (US); Hanna Kroukamp, London (GB)

(73) Assignee: MICROSOFT CORPORATION, Redmond, WA (US)

(21) Appl. No.: 13/711,589

(22) Filed: Dec. 11, 2012

(51) Int. Cl. G06Q 30/02

(52) U.S. Cl. CPC G06Q 30/0202
USPC 705/7.31

(57) ABSTRACT

Various embodiments provide an ability to detect an input associated with an element for which a cascading operation has been defined. Some embodiments apply the cascading operation to the element, and further apply one or more cascading operations to less than all ancestral elements in an associated tree for which cascading operations have been defined. In some cases, the one or more cascading operations can be applied to one or more respective ancestral elements after a predefined waiting period.

### BACKGROUND

Developing and maintaining products can sometimes be an ongoing process. As an example, when a product is deployed to users, usage information associated with the product can be gathered as a means for feedback on how well the product is working, whether the product is meeting projected targets, and so forth. Depending upon results determined from the usage information, adjustments may be made to product features, to how the product is deployed to users, and so forth. Traditionally, product developers pre-determine what data to gather associated with the usage information and which static data analysis routines to utilize to generate metrics that qualify how a product is working. In some cases, these metrics and/or data analysis routines can be based upon pre-determined models as a means to predict future behaviors. Provided the gathered usage information data fits the pre-determined model, the static data analysis routines generate somewhat realistic metrics associated with the product, and advantageous decisions can be made based upon predicted future behavior. Data falling outside of the pre-determined model, however, yields less realistic, and even potentially erroneous results. In these scenarios, any adjustments made to the product based upon false expectations can produce undesirable and/or adverse results. To further compound this problem, some products can generate a large volume of data depending upon its number of users, making analysis of the metrics more difficult.

### SUMMARY

This Summary is provided to introduce a selection of concepts in a simplified form that are further described below in the Detailed Description. This Summary is not intended to identify key features or essential features of the claimed subject matter.

Various embodiments generate at least one heuristic for a historical set of data. In some cases, the historical set of data can be divided into a plurality of partitions. Responsive to generating the heuristic(s) for the historical set of data, some embodiments generate at least one forecast based, at least in part on the heuristic(s) associated with the historical set of data. Alternately or additionally, heuristic(s) can be generated for an incoming set of data, and compared to the forecast(s) effective to determine one or more forecast quality metrics. Alternately or additionally some embodiments use the forecast quality metric(s) to prompt additional processing.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation in accordance with one or more embodiments.

FIG. 2 is an illustration of a system in an example implementation showing FIG. 1 in greater detail.

FIG. 3 is an illustration of an example diagram of a data heuristics engine in accordance with one or more embodiments

FIG. 4 is an illustration of aspects of an example implementation in accordance with one or more embodiments.

FIGS. 5a and 5b are illustrations of aspects of example implementations in accordance with one or more embodiments.

FIG. 6 illustrates a flow diagram in accordance with one or more embodiments.

FIG. 7 illustrates an example computing device that can be utilized to implement various embodiments described herein.

### DETAILED DESCRIPTION

Overview

Various embodiments generate at least one heuristic for a historical set of data. For example, data associated with a system and/or product's past performance can be collected and/or stored in a repository. In some cases, the historical set of data can be divided into a plurality of partitions, and heuristic(s) can be generated for each partition. The size of each partition can be variable and/or fixed in length relative to one another. Alternately or additionally, the size of a partition can be based, at least in part, on a characteristic and/or property associated with the historical data being analyzed. Responsive to generating the heuristic(s) from the historical data, some embodiments generate one or more forecasts based, at least in part, on the heuristic(s). For example, a forecast can be generated from the heuristic(s) to project and/or anticipate future behavior(s) of the system and/or product. Some embodiments store the forecast(s) in a repository for future use, as further discussed below. Responsive to receiving new and/or incoming data, some embodiments generate heuristic(s) on the new/incoming data. As in the case of the historical data, the new/incoming data can be partitioned, and multiple heuristics can be generated for each new or additional partition. In some cases, the new/incoming data can be partitioned several times based upon the heuristic being generated (e.g. the same set of data may be re-partitioned several times, each partition being associated with a specific heuristic). The new heuristic(s) can be compared to the forecast(s) effective to enable generation of forecast quality metric(s). In some cases, the forecast quality metric can indicate whether an associated forecast had a high quality and/or degree of accuracy, a low quality and/or degree of accuracy, and so forth, in predicting behavior(s). Responsive to determining a high quality and/or degree of accuracy, some embodiments store the new incoming data in a repository. Alternately or additionally, some embodiments trigger a notification based upon low quality accuracy metric(s) and can, in some cases, quarantine the new incoming data for further analysis before and/or instead of storing the new incoming data in the repository.

In the discussion that follows, a section entitled “Example Operating Environment” is provided and describes one environment in which one or more embodiments can be employed. Following this, a section entitled “Qualifying Data Quality” describes how heuristic methods, coupled with forecasting models, can be utilized to measure data quality in accordance with one or more embodiments. Last, a section entitled “Example Device” describes an example device that can be utilized to implement one or more embodiments

Having provided an overview of various embodiments that are to be described below, consider now an example operating environment in which one or more embodiments can be implemented.

Example Operating Environment

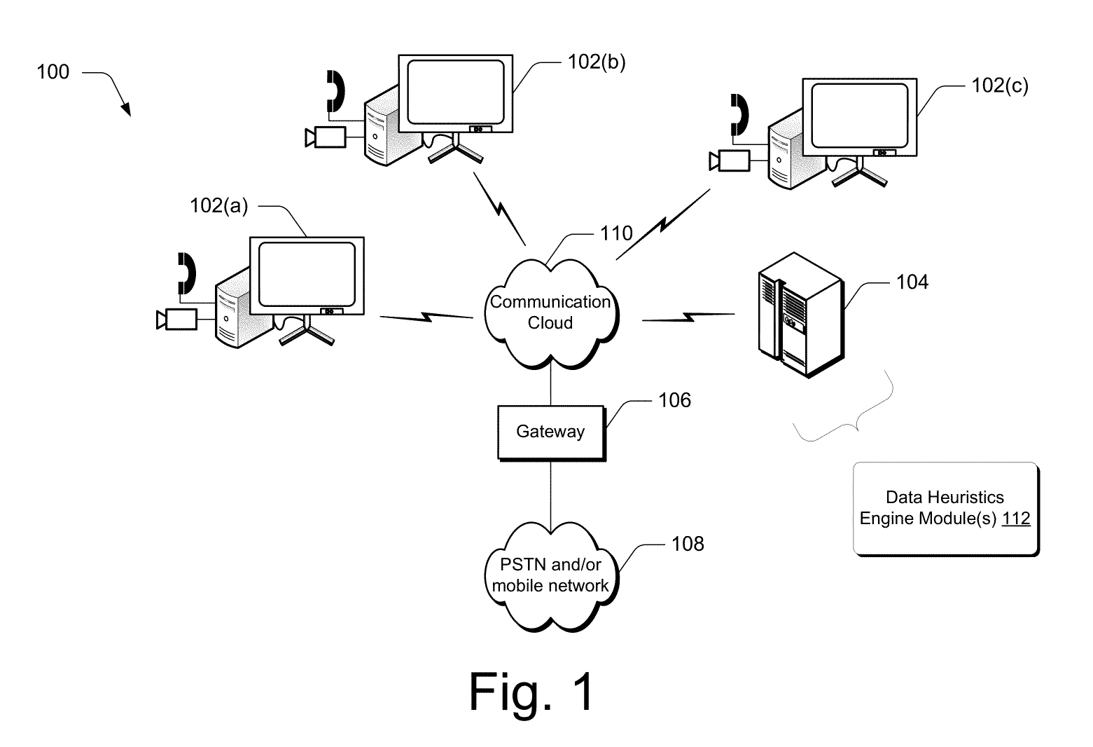

FIG. 1 is a schematic illustration of a communication system 100 implemented over a packet-based network, here represented by communication cloud 110 in the form of the Internet, comprising a plurality of interconnected elements. It is to be appreciated that, while aspects of the current invention are described with reference to communication system 100, these discussions are merely for illustrative purposes, and are not intended to limit the scope of the claimed subject matter. Each network element is connected to the rest of the Internet, and is configured to communicate data with other such elements over the Internet by transmitting and receiving data in the form of Internet Protocol (IP) packets. Each element also has an associated IP address locating it within the Internet, and each packet includes a source and destination IP address in its header. The elements shown in FIG. 1 include a plurality of end-user terminals 102(a) to 102(c) (such as desktop or laptop PCs or Internet-enabled mobile phones), one or more servers 104 (such as a peer-to-peer server of an Internet-based communication system, a data center server, and so forth), and a gateway 106 to another type of network 108 (such as to a traditional Public-Switched Telephone Network (PSTN) or other circuit switched network, and/or to a mobile cellular network). However, it will of course be appreciated that many more elements make up the Internet than those explicitly shown. This is represented schematically in FIG. 1 by the communications cloud 110 which typically includes many other end-user terminals, servers and gateways, as well as routers of Internet service providers (ISPs) and Internet backbone routers.

In the illustrated and described embodiment, end-user terminals 102(a) to 102(c) can communicate with one another, as well as other entities, by way of the communication cloud using any suitable techniques. Thus, end-user terminals can communicate with one or more entities through the communication cloud 110 and/or through the communication cloud 110, gateway 106 and network 108 using, for example Voice over Internet Protocol (VoIP). In order to communicate with another end user terminal, a client executing on an initiating end user terminal acquires the IP address of the terminal on which another client is installed. This is typically done using an address look-up.

Some Internet-based communication systems are managed by an operator, in that they rely on one or more centralized, operator-run servers for address look-up (not shown). In that case, when one client is to communicate with another, then the initiating client contacts a centralized server run by the system operator to obtain the callee's IP address.

In contrast to these operator managed systems, another type of Internet-based communication system is known as a “peer-to-peer” (P2P) system. Peer-to-peer (P2P) systems typically devolve responsibility away from centralized operator servers and into the end-users' own terminals. This means that responsibility for address look-up is devolved to end-user terminals like those labeled 102(a) to 102(c). Each end user terminal can run a P2P client application, and each such terminal forms a node of the P2P system. P2P address look-up works by distributing a database of IP addresses amongst some of the end user nodes. The database is a list which maps the usernames of all online or recently online users to the relevant IP addresses, such that the IP address can be determined given the username.

Once known, the address allows a user to establish a voice or video call, or send an IM chat message or file transfer, etc. Additionally however, the address may also be used when the client itself needs to autonomously communicate information with another client.

Server(s) 104 represent one or more servers connected to communication system 100, examples of which are provided above and below. For example, servers 104 can include a bank of servers working in concert to achieve a same functionality. Alternately or additionally, servers 104 can include a plurality of independent servers configured to provide functionality specialized from other servers. In some embodiments, server(s) 104 include one or more data heuristics engine module(s) 112. Data heuristics engine module(s) 112 represent functionality configured to analyze historical data and generate heuristic(s) based upon the historical data. Here, historical data includes any data collected to describe and/or document past events, behavior, characteristics, and so forth associated with an item (e.g. product, system, service, client application, etc.). Any suitable type of data can be analyzed, as further described below. In some cases, heuristics are generated for the historical data as a whole set, while in other cases heuristics are generated for smaller portions and/or partitions of the historical data. Upon generating the heuristic(s), data heuristics engine module(s) 112 can additionally generate forecast(s) associated with the heuristic(s). For example, some embodiments can generate a forecast using various forecasting models, such as Holt-Winters, linear regression, Gaussian, and so forth. Data heuristics engine module(s) 112 can additionally store the forecast(s) in a repository for future use. While not illustrated here, it is to be appreciated that the repository can be internal and/or external to the server(s) 104 which host(s) data heuristic engine module(s) 112.

In addition to analyzing historical data, data heuristics engine module(s) 112 can analyze (new and/or current) incoming data, such as, by way of example and not limitation, data characterizing and/or associated with interactions between end-user terminals 102(a), 102(b), 102(c), and/or network 108. In some embodiments, data heuristics engine module(s) 112 generates similar heuristic(s) on the incoming data as those generated for the historical data, and compare the new heuristics to the forecast(s) stored in the repository. Alternately or additionally, data heuristics engine module(s) 112 calculates a forecast quality metric configured to identify how closely the forecast(s) matched the metrics associated with incoming data. If the forecast quality metric indicates a low quality and/or inaccurate forecast, data heuristics engine module(s) 112 can trigger and/or send a notification to interested parties. At times, data heuristics engine module(s) 112 quarantines the incoming data associated with inaccurate forecast(s) from the historical data until a point in time where the incoming data can be further analyzed. In some embodiments, if the metric(s) associated with the incoming data match the forecast(s) to within a pre-determined threshold and/or variance, data heuristics engine module(s) stores the new incoming data into a data repository and/or updates forecast(s) based upon the new incoming data.

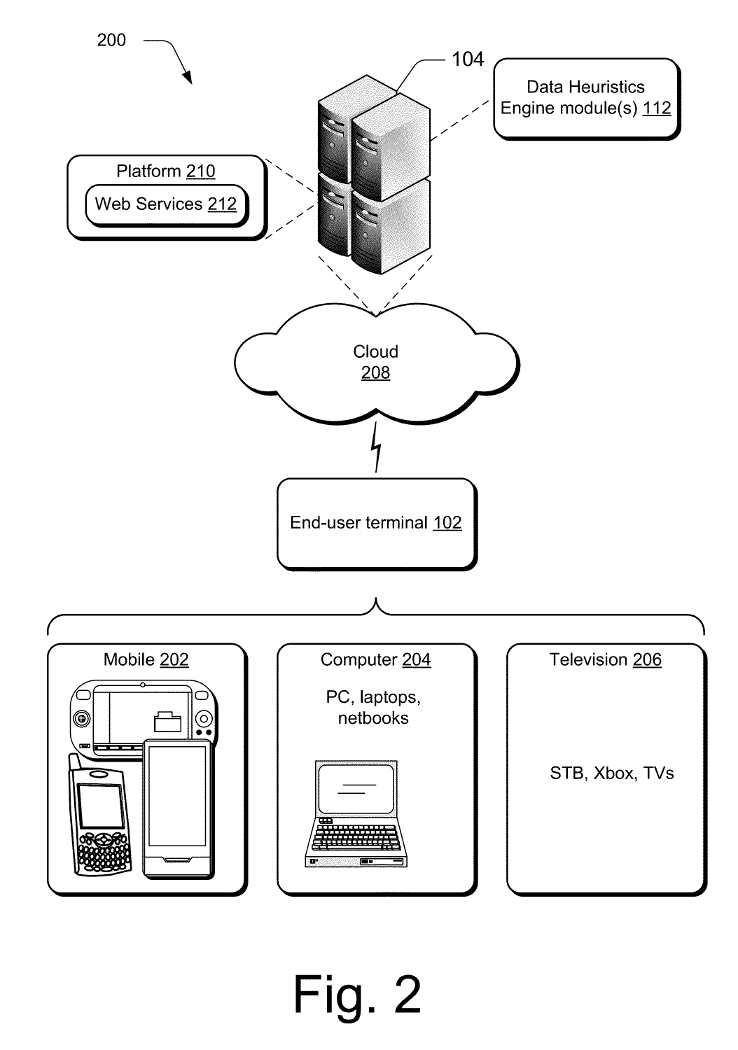

FIG. 2 illustrates an example system 200 generally showing server(s) 104 and end-user terminal 102 as being implemented in an environment where multiple devices are interconnected through a central computing device.

The central computing device may be local to the multiple devices or may be located remotely from the multiple devices. In one embodiment, the central computing device is a “cloud” server farm, which comprises one or more server computers that are connected to the multiple devices through a network or the Internet or other means.

In one embodiment, this interconnection architecture enables functionality to be delivered across multiple devices to provide a common and seamless experience to the user of the multiple devices. Each of the multiple devices may have different physical requirements and capabilities, and the central computing device uses a platform to enable the delivery of an experience to the device that is both tailored to the device and yet common to all devices. In one embodiment, a “class” of target device is created and experiences are tailored to the generic class of devices. A class of device may be defined by physical features or usage or other common characteristics of the devices. For example, as previously described, end-user terminal 102 may be configured in a variety of different ways, such as for mobile 202, computer 204, and television 206 uses. Each of these configurations has a generally corresponding screen size and thus end-user terminal 102 may be configured as one of these device classes in this example system 200. For instance, the end-user terminal 102 may assume the mobile 202 class of device which includes mobile telephones, music players, game devices, and so on. The end-user terminal 102 may also assume a computer 204 class of device that includes personal computers, laptop computers, netbooks, and so on. The television 206 configuration includes configurations of device that involve display in a casual environment, e.g., televisions, set-top boxes, game consoles, and so on. Thus, the techniques described herein may be supported by these various configurations of the end-user terminal 102 and are not limited to the specific examples described in the following sections.

In some embodiments, server(s) 104 include “cloud” functionality. Here, cloud 208 is illustrated as including a platform 210 for web services 212. The platform 210 abstracts underlying functionality of hardware (e.g., servers) and software resources of the cloud 208 and thus may act as a “cloud operating system.” For example, the platform 210 may abstract resources to connect end-user terminal 102 with other computing devices. The platform 210 may also serve to abstract scaling of resources to provide a corresponding level of scale to encountered demand for the web services 212 that are implemented via the platform 210. A variety of other examples are also contemplated, such as load balancing of servers in a server farm, protection against malicious parties (e.g., spam, viruses, and other malware), and so on. Thus, the cloud 208 is included as a part of the strategy that pertains to software and hardware resources that are made available to the end-user terminal 102 via the Internet or other networks.

Alternately or additionally, servers 104 include data heuristics engine module(s) 112 as described above and below. In some embodiments, platform 210 and data heuristics engine module(s) 112 can reside on a same set of servers, while in other embodiments they reside on separate servers. Here, data heuristics engine module(s) 112 is illustrated as utilizing functionality provided by cloud 208 for interconnectivity with end-user terminal 102.

Generally, any of the functions described herein can be implemented using software, firmware, hardware (e.g., fixed logic circuitry), manual processing, or a combination of these implementations. The terms “module,” “functionality,” and “logic” as used herein generally represent software, firmware, hardware, or a combination thereof. In the case of a software implementation, the module, functionality, or logic represents program code that performs specified tasks when executed on or by a processor (e.g., CPU or CPUs). The program code can be stored in one or more computer readable memory devices. The features of the gesture techniques described below are platform-independent, meaning that the techniques may be implemented on a variety of commercial computing platforms having a variety of processors.

Having described example operating environments in which various embodiments can be utilized, consider now a discussion of qualifying data quality in accordance with one or more embodiments.

Qualifying Data Quality

Metrics and/or heuristics can be used to identify and/or qualify numerous different types of items, such as characteristics of a product, user interactions with the products, system level responsiveness, and so forth. As one example, some metrics tabulate how often a user accesses an Internet service during a 24 hour period. In addition to tabulating how often the user accesses the Internet service during a 24 hour period, metrics can identify times during the day when the user accesses the Internet service more often than others. To better serve the user, a developer of the Internet service can use metrics as a way to qualify how well the Internet service is working and/or how the Internet service being used. These metrics can also be “extended” to anticipate future needs associated with a product (such as the Internet service). Forecasts based off of the metrics and/or heuristics can help identify future scenarios, help anticipate future needs associated with a product, and subsequently help tailor the product based upon the future needs. Provided the forecasts accurately predict future behaviors, the end result can yield a product that better serves targeted users. However, when the forecasts incorrectly predict behaviors, this can result in unnecessary changes to the product or, in some drastic cases, changes that adversely affect users.

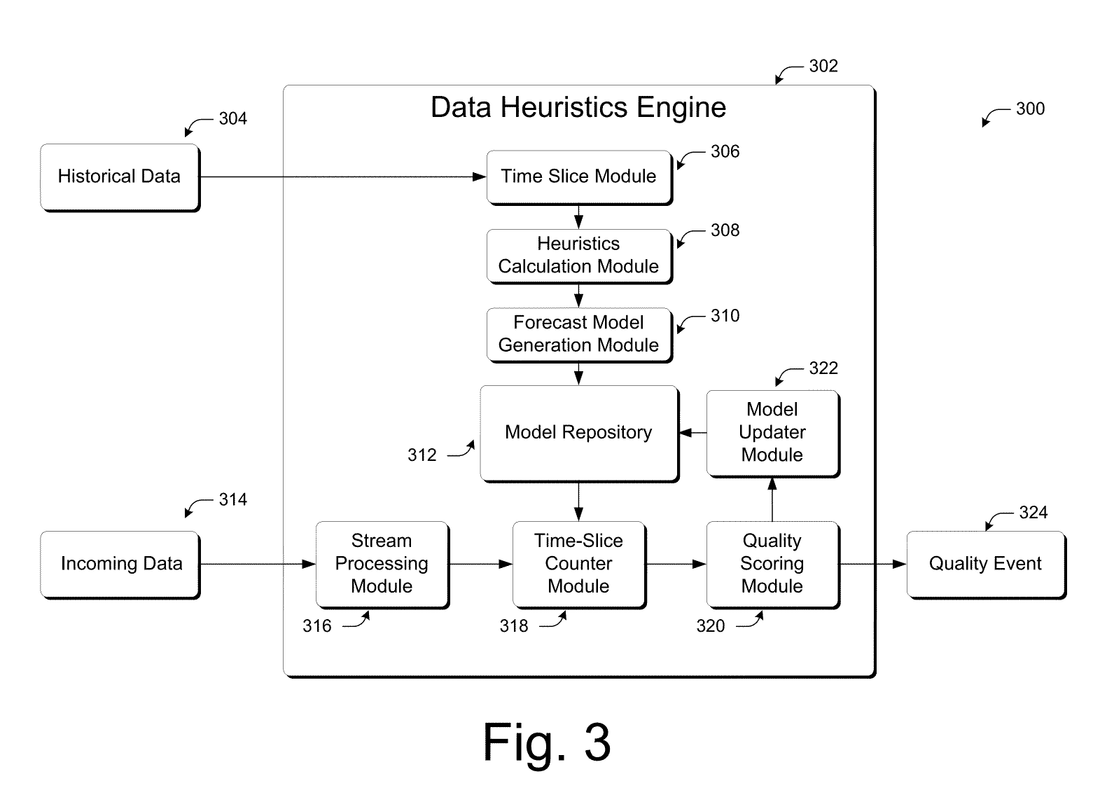

To reduce the potential of erroneous forecasts, some embodiments qualify an accuracy associated with the forecast(s). To do so, at least some embodiments can utilize a data heuristics engine. As an example, consider FIG. 3, which generally illustrates an environment 300 which includes data heuristics engine 302. In the illustrated and described example, data heuristics engine 302 includes a time-slice module 306, a heuristics calculation module 308, a forecast model generation module 310, a model repository 312, a stream processor module 316, a time slice counter module 318, a quality scoring module 320, and a model updater module 322, all of which are described below in more detail. Among other things, data heuristics engine 302 analyzes historical data to generate heuristic(s), generate forecast(s) based on the heuristics, and/or generate forecast quality metrics based upon current and/or incoming data, as further described below.

Environment 300 includes historical data 304, illustrated here as an input to data heuristics engine 302. In some embodiments, historical data 304 can reside in a data repository and/or memory located on a same computing device that hosts data heuristics engine 302. Alternately or additionally, historical data 304 can reside external to the computing device hosting data heuristics engine 302. Historical data 304 can comprise any suitable type of data associated with characterizing an object/product/service, interactions of a user with the object/product/service, interactions of the object/product/service with other components, and so forth. For instance, referring to the above example of an Internet service, historical data 304 can include data characterizing the Internet service (e.g. where it pulls resources from, how often it pulls resources, how often it refreshes a screen, how often the Internet service crashes, what kind of service it is, etc.), data characterizing user interactions with the Internet service (how many users interact with the Internet service, how often a particular user interacts with the Internet service, what time of day is the Internet Service more active, what type of users are requesting the service, a region associated with the user requesting the service, what kind of service the user is requesting, what version of software the users are running, what Operating System (OS) an associated client is running, what type of links the user clicks on, how many unique users are using the service per hour, what percentage of users are from one or more specific regions, etc.), can include information that characterizes the data itself (e.g. timestamps of when the data was collected, a data type, data origin information, etc.), what an average network latency associated with the service is, and so forth. In some cases, historical data 304 can be data collected over time. For example, historical data 304 can be composed of several files and/or groupings of data, wherein each grouping represents a 24-hour span of data collection. It is to be appreciated and understood, however, that these examples are merely used for illustrative purposes, and are not intended to limit the scope of the claimed subject matter. Alternately or additionally, historical data 304 can include multiple types and/or mixtures of data. Thus, historical data 304 represents any suitable type, collection, and/or grouping of data. Further, historical data can comprise any suitable scale or amount of data (e.g. billions of entries, millions of entries, trillions of entries, and so forth).

Time-slice module 306 of data heuristics engine 302 divides historical data 304 into one or more time slices. In some embodiments, the historical data can be partitioned into equally sized time-slices. Alternately or additionally, the historical data can be partitioned into varying sized time-slices. Consider a case where historical data 304 contains groupings of data collected over a defined period of time, e.g., a 24-hour period. Time-slice module 306 can be configured to partition historical data into equal time-slices comprising 24 1-hour time-slices, 48 equal 30 minute time-slices, etc. Alternately, time-slice module 306 can be configured to partition the historical data into varying sized time slices over the 24-hour span based upon characteristics of the data. For instance, in one scenario, data collected between 12:00 AM to 6:59 AM can be partitioned into 1 hour time-slices, data collected between 7:00 AM-5:59 PM can be partitioned into 15 minute time-slices, data collected between 6:00 PM-9:59 PM can be partitioned into 10 minute time-slices, and data collected between 10:00 PM and 11:59 PM can be partitioned into 30 minute time-slices. In this example, the time-slice size is based, at least in part, on what time of day the historical data was collected, and subsequently the time-slices vary in size over the 24-hour time period. However, it is to be appreciated that a size of a time-slice can be based on any suitable combination of characteristics. For instance, consider a case where historical data 304 includes data representing new users who access an Internet service and data representing a two-way communication event. The data associated with new users who access the Internet service may be partitioned into 12 hour time-slices, while data representing the two-way communication event may be partitioned into 1 minute time-slices for the duration of the two-way communication event. Thus, time-slice module 306 can divide historical data 304 into time-slices based upon one or more characteristics of the data being time-sliced, and can alternately or additionally create time slices of fixed or varying sizes.

Heuristics calculation module 308 calculates one or more heuristic(s) for each time-slice generated by time-slice module 306. Any suitable type of heuristic can be calculated, such as, by way of example and not limitation, a count, sum, average, cardinality, actual measured duration of a record, average measured duration of a group of records, histograms, and so forth. Further, heuristic(s) can be stored in any suitable unit and/or format, such as a raw value, a percentage value, a normalized value, and so forth. In some cases, heuristic(s) can be further partitioned and stored based upon sub-categories, such as partitioned by region, associated hardware and/or OS platform of the client(s), and so forth. Alternately or additionally, multiple heuristics can be generated for each time slice. In some cases, the type of heuristic(s) generated can be based upon a type of data being analyzed. For instance, data associated with tracking call access through an Internet service might generate a “service access count” heuristic or “number of different users” heuristic, while data associated with a specific call or a specific user might generate a “call duration” heuristic and/or a “user call count” heuristic.

Forecast model generation module 310 generates one or more forecasts based upon the generated heuristics of heuristics calculation module 308. Any suitable type of forecasting model can be used, such as, by way of example and not limitation, a Holt-Winters model, a Gaussian classifier model, a liner prediction model, a moving average model, a weighted moving average model, an extrapolation model, a trend estimation model, and so forth. Upon generating the forecast(s), forecast model generation module 310 can store the models in model repository 312. For illustrative purposes, model repository 312 is shown as residing within data heuristic engine 302. However, it is to be appreciated and understood that model repository 312 can reside external to data heuristic engine 302 without departing from the scope of the claimed subject matter. For example, model repository 312 can reside on hardware separate from data heuristic engine 302, and blocks of data heuristic engine 302 (such as modules 310, 318, 320 and/or 322) can be configured to store and pull models to/from the external hardware.

Once the forecast(s) generated based upon historical data 304 have been stored in model repository 312, data heuristics engine 302 compares the forecast(s) to incoming data 314, as further discussed below. In some embodiments, incoming data 314 comprises similar data to that stored in historical data 304, examples of which are described above. Further, incoming data 314 can be received by data heuristics engine 302 in any suitable fashion, such as through communication cloud 110 of FIG. 1 and/or cloud 208 of FIG. 2. Incoming data 314 can be received in any suitable fashion, e.g., in “real-time” (as an associated event occurs), in groups of data, and/or received by querying a database, and the like. For instance, end-user terminal 102(a) of FIG. 1 can be configured to forward incoming data 314 to server(s) 104 hosting data heuristics engine 302 as events occur and/or store incoming data 314 in a data repository external to data heuristics engine 302. Thus, incoming data 314 can be transmitted directly to data heuristics engine 302 and/or queried from a data repository. Here, FIG. 3 illustrates incoming data 314 being directly received by the data heuristics engine via stream processing module 316. To further illustrate, consider a scenario where network latency is being monitored. Based upon historical data, an expectation is set that for the hours of 8:00 AM to 10:00 AM, network traffic in the United States will have an average latency of 200 milliseconds (msec.), with a standard projected error of 10%. It is to be appreciated that these values are for discussion purposes, and are in no way intended to limit the scope of the claimed subject matter. By monitoring the incoming data in real-time, the associated network traffic latency is measured to have an average latency of 2 seconds, which falls outside of the acceptable 10% error range. As further discussed below, this monitoring mechanism can be utilized to notify interested parties of the deviation from expected behavior.

In one or more embodiments, stream processing module 316 captures incoming data 314 in “real-time” and stores the data into associated memory. While FIG. 3 illustrates stream processing module 316 as capturing incoming data 314, it is to be appreciated that the data can be captured in other ways such as, by way of example and not limitation, by querying a data repository.

Time-slice counter module 318 is operably coupled with stream processor module 316 and is configured to separate and/or divide incoming data 314 into partitions and/or blocks, such as partitions similar to those described above with reference to time-slice module 306 and historical data 304. In some cases, time-slice counter module 318 can determine partition size(s) based upon a type of data associated with incoming data 314, and vary the partition size(s) accordingly. Alternately or additionally, partition size(s) can be based upon a type of forecast associated with the data. For example, some embodiments can acquire partition sizing from model repository 312 and/or the forecast(s) stored in model repository 312, and use this information to set or adjust how incoming data 314 is partitioned by time-slice counter module 318. This enables a more balanced comparison between incoming data 314 and forecast(s) based upon the metrics generated using a same measure of time, as further described below.

Upon partitioning incoming data 314, data heuristics engine 302 compares the current incoming data to one or more forecast models, such as those stored in model repository 312. For example, in some embodiments time-slice counter module 318 can generate one or more heuristics on the current incoming data, such as heuristics similar to that calculated by heuristics calculation module 308. In some embodiments, time-slice counter 318 can be the same module as time-slice module 306. In other embodiments, time-slice counter 318 is a separate module from time-slice module 306. Alternately or additionally, time-slice counter module 318 can send the current incoming data to heuristics calculation module 308 to calculate additional heuristics. As in the case above, time-slice counter 318 can partition incoming data 314 in multiple way (e.g. the same set of data can be partitioned several times in differing ways for each heuristic to be generated on the set of data). Quality scoring module 320 represents functionality that performs this comparison between the incoming data (and/or associated heuristic) with the forecast models, and calculates a “forecast quality metric” to qualify this comparison. By way of example and not of limitation, quality scoring module 320 can calculate a variance value between a forecast value and a value generated from incoming data 314 as an indicator of how close the two values match. It is to be appreciated and understood that other types of forecast quality metrics can be used to qualify the comparison and/or forecast(s) without departing from the scope of the claimed subject matter, such as percentage of difference, frequency of deviance, degree of standard deviation, a time series associated with the time window being utilized, an average deviance of the forecast model versus the actual data, calculating a Gaussian distribution of errors, and so forth. Alternately or additionally, a same algorithm can be used over different ranges and/or time-slices of data as a way to measure an accuracy of the algorithm, and/or different algorithms can be utilized on different forecast models to determine which forecast yields more accurate results. In some embodiments, the forecast quality metric can be compared to one or more threshold(s). Among other things, this can automate how a forecast's quality is determined. Alternately or additionally, quality scoring module 320 can publish results of the scoring process to one or more requesting, subscribing, and/or receiving queues.

If the forecast quality metric used to qualify the forecast indicates the forecast was accurate within an acceptable margin, some embodiments update the forecasting model(s) stored in model repository 312, such as through the use of model updater module 322. Similar to forecast model generation module 310, model updater module 322 generates forecast(s) from the incoming data 314 and/or one or more forecasting model(s). In some embodiments, model updater module 322 can build upon existing models by adding on/accumulating information to forecasts stored in model repository 312. Alternately or additionally, model updater module 322 replaces and/or overwrites forecast(s) stored in model repository 312 with newly generated ones. However, if the forecast quality metric indicates that a forecast was not as accurate as desired, data heuristics engine 302 can process incoming data in a different manner.

Consider the above example of comparing the forecast quality metric to one or more thresholds. In at least one embodiment, multiple thresholds can be used to identify a status type, e.g., a “green” status, a “yellow” status, and/or a “red” status. A first threshold can be defined to indicate an acceptable margin of error and/or where a forecast model is considered to have accurately predicted behavior(s) of a product and/or system (such as the incoming data being less than 2% variance from the forecast). A second threshold can be defined to indicate a warning, or the “yellow” status, that a forecast model was less accurate than the “green” status, but still within acceptable margins (such as more than 2% variance, but less than 10% variance). A third threshold, associated with the “red” status, can be defined to indicate that the forecast model is much less accurate than expected (e.g. more than 10% variance). In the case of the “green” status, the associated incoming data can be processed as discussed above. However, in the case of identifying the “yellow” and/or “red” status, some embodiments trigger a quality event, such as quality event 324 that can lead to additional processing.

In one or more embodiments, quality event 324 generates notifications and/or alerts of potential problems to interested user(s) which, in turn, can automatically and/or proactively identify problem(s) at an early stage. For example, consider the case where histograms are created. Based on past data, a forecast is generated that predicts 30% of users will be based in North America, and/or that 25% of the users will be using a particular OS. In some embodiments, a tolerance and/or threshold can be set to indicate an acceptable level accuracy in the forecast, such as a setting a threshold of a standard deviation of 1. Detecting that incoming data deviates more than the tolerance level can, in some cases, indicate that the forecast quality is poor, that some event of business value is taking place (such as faulty and/or buggy client code on the particular OS), that an associated data center is “down” or non-functioning, and so forth. The heuristics can additionally notify requesting parties and/or interested users of these events, who, in turn, can decide on what actions to perform in response to the event(s). Interested users can include system administrators or those who have administrative oversight of the system. In some embodiments, the incoming data associated with the quality event can be isolated and/or quarantined from model repository 312 and/or model updater module 322 until a further investigation has been completed. For instance, a “yellow” and a “red” status may each cause quality scoring 318 to generate quality event 324 and an associated notification, while a “red” status additionally causes data to be quarantined.

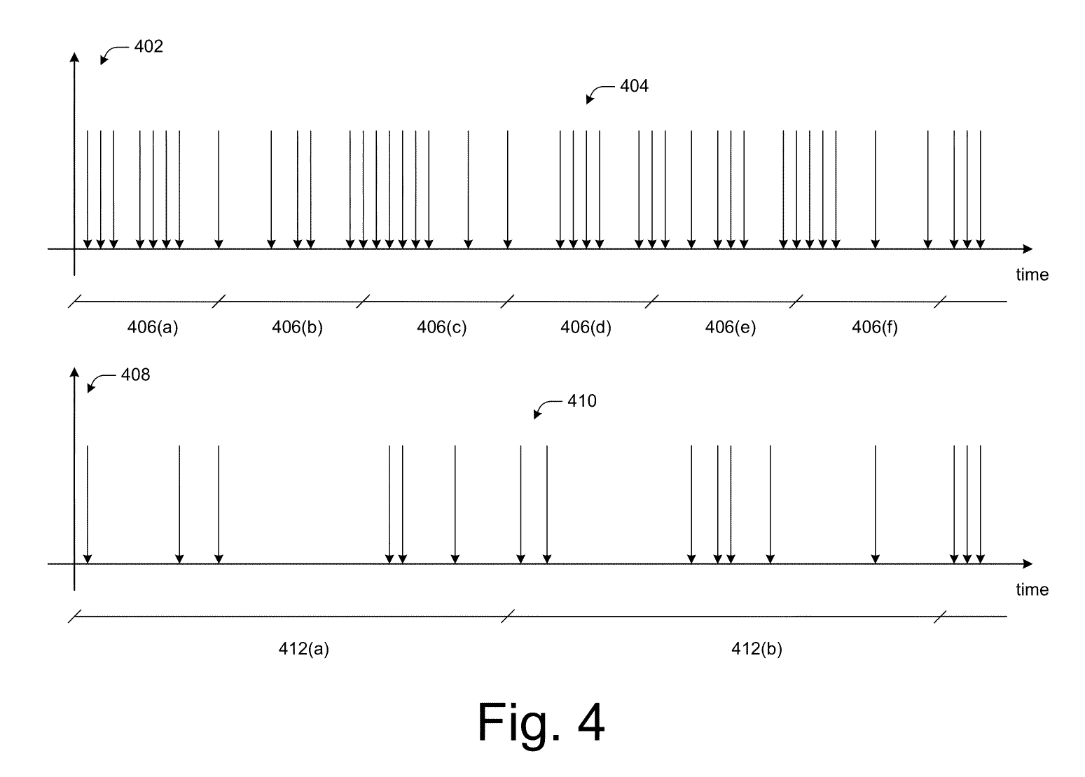

To further illustrate, consider FIG. 4, which shows two separate data collections over time, such as those described with respect to historical data 304 and/or incoming data 314 of FIG. 3. Timeline 402 shows a series of data points 404, and associated partitions 406(a-f), while timeline 408 illustrates data points 410 and associated partitions 412(a-b). It is to be appreciated that these series of data collection can represent data collections gathered at any arbitrary point in time. Furthermore, data points 404 and 410 as represented in FIG. 4 are merely used for illustrative purposes, and can represent any suitable type and/or mix of data, examples of which are provided above.

For discussion purposes, assume timeline 402 represents a historical data collection gathered between 7:00 AM to 8:30 AM, while timeline 408 represents a historical data collection gathered between 2:00 AM to 3:30 AM. It can be noted that timeline 402 includes more data points than timeline 408, thus indicating a higher volume of activity during the hours of 7:00 AM to 8:30 AM than 2:00 AM to 3:30 AM. In some embodiments, the partition size associated with partitions 406(a-f) and 412(a-b) can be based, at least in part, upon a time in which the data was collected. Here, since timeline 402 occurs during a time period identified as having a high volume of activity, partitions 406(a-f) have been sized accordingly (represented here as 15 minute partitions) to give further granularity to the time space. Conversely, since timeline 408 occurs during a period identified as having a low volume of activity, partitions 412(a-b) have been sized larger than partitions 406(a-f) (represented here as 45 minute partitions). While these examples are discussed as being partition based upon a time period of high or low volume, it is to be appreciated and understood that other characteristics can be used without departing from the scope of the claimed subject matter. Alternately or additionally, the size of a time-slice can be statically set and/or uniform in size. As another example, data points 404 can represent data indicating two-way communication events between select users, while the data points 410 can represent data indicating first-time-user-access. As described above, these different types and/or characterizations associated with the data can change how “often” the data is analyzed and/or partitioned.

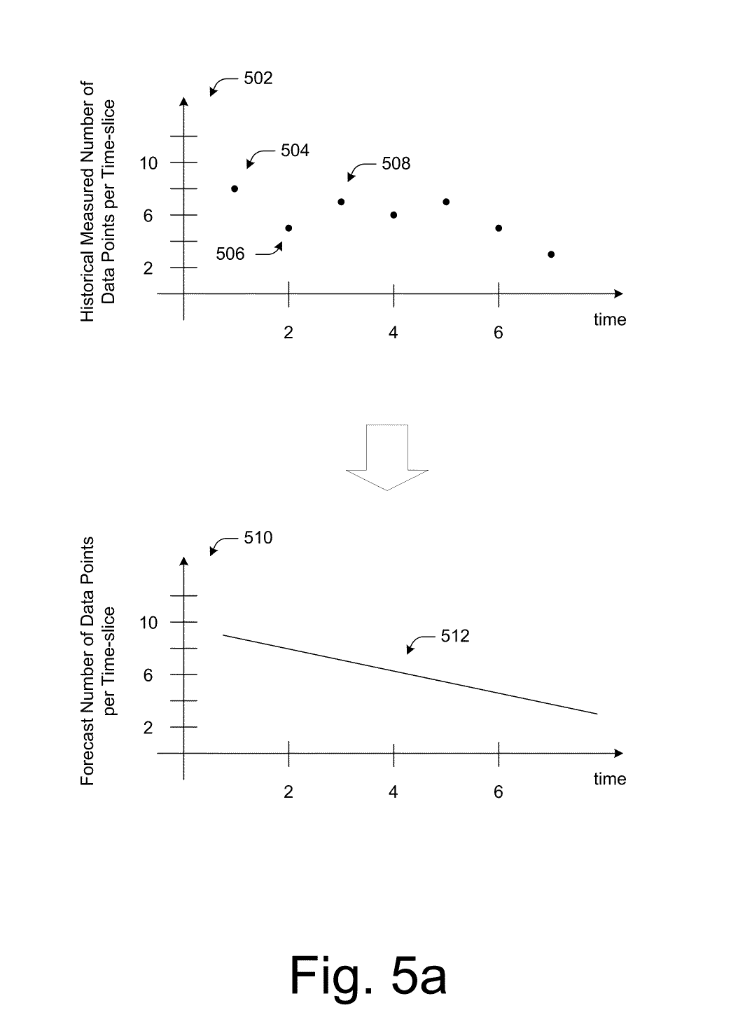

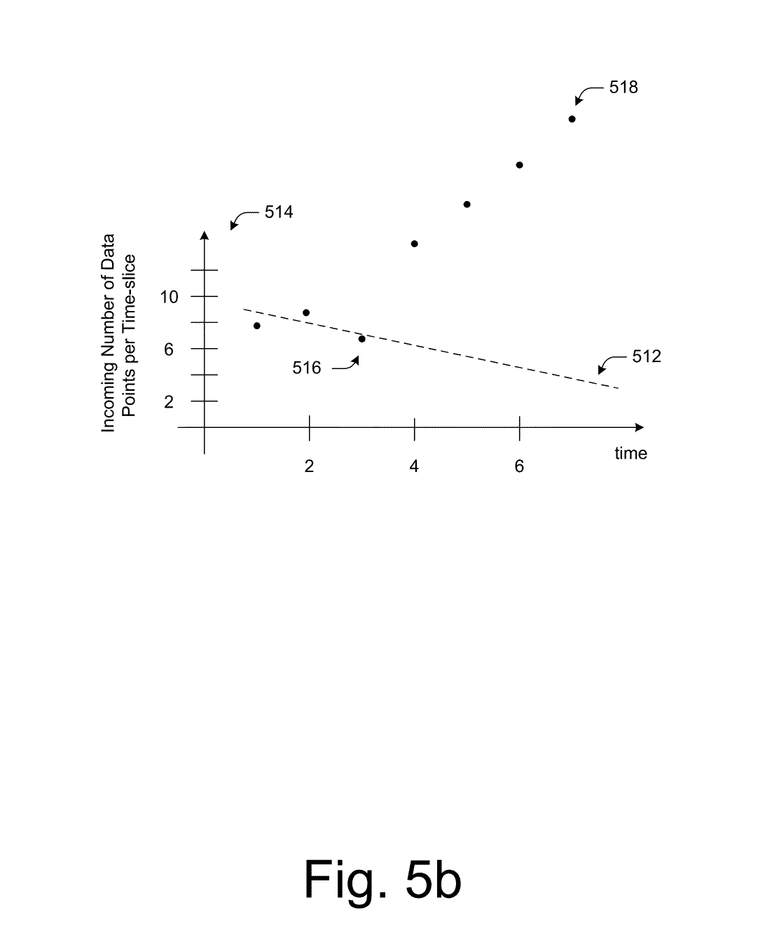

Continuing with the above example, consider FIGS. 5a and 5b. Graph 502 is a heuristic graph associated with timeline 402 of FIG. 4. In this example, the heuristic calculated represents a number of data points per time-slice. For instance, point 504 indicates that partition 406(a) of timeline 402 has a measured value of eight data points. Similarly, point 506 shows that partition 406(b) contains a measured value of five data points, point 508 shows that partition 406(c) as a value of seven data points, and so forth. Responsive to generating this heuristic, the information can be used to generate forecast(s) based upon one or more forecast models.

Graph 510 illustrates forecast 512. For discussion purposes, assume forecast 512 has been generated using a linear prediction algorithm that has been based off of the heuristics captured in graph 502. It is to be appreciated that, as described above, any suitable type of forecasting model can be utilized without departing from the scope of the claimed subject matter. Furthermore, while FIG. 5a only illustrates one metric (e.g. measured number of data points per time-slice) and one forecast (e.g. forecast 512), a multitude of metrics and/or forecasts can be created. In graph 510, forecast 512 predicts that a future data collection will include roughly nine data points for a first time-slice, eight data points for a second time-slice, and so forth. Once generated, forecast 512 can be stored in memory and/or a data repository, such as model repository 312 of FIG. 3, for future use.

Continuing on, FIG. 5b illustrates graph 514, which contains heuristics generated from incoming data, such as incoming data 314 of FIG. 3. Similar to that of graph 502, the heuristic generated for graph 514 captures a number of data points per time-slice. For example, point 516 indicates seven data points for a third partition, while point 518 indicates twenty-three data points for a seventh partition. In addition to generating the heuristic for incoming data 314, graph 514 includes a comparison between the incoming data heuristics (such as points 516 and 518) and forecast 512 from FIG. 5a. Based upon this comparison, it is implied that the partition size used to generate points 516 and 518 is a same partition size as that used to generate forecast 512. In analyzing the forecast with the newly generated heuristic, it is noted that point 516 closely matches forecast 512. In one embodiment, a forecast quality metric can be generated for the comparison between point 516 and forecast 512, such as a variance value associated with how much point 516 deviates from forecast 512. For point 516, since the forecast closely predicted the value, the variance might indicate a smaller value. However, for point 518, since it is noted that since point 518 deviates further from forecast 512 than other points of comparison, the variance value would have a higher value. Thus, comparing a variance generated for point 516 to a threshold might indicate that forecast 512 was “on track” for point 516, but comparing the variance generated for point 518 to the same threshold might indicate that forecast 512 for that point was outside of a desired range of accuracy. In some embodiments, being outside of a desired range of accuracy would trigger a quality event and/or associated actions, as further described above.

The aforementioned examples discuss generating heuristics and forecasts based upon historical and incoming data as a means to generate a forecast quality metric. By qualifying a forecast through the use of a forecast quality metric, not only does a developer obtain information of how to anticipate future needs of users, but such can improve the forecasting process by monitoring how well a forecast modeled expected future needs, and additionally trigger an event or notification when unexpected results occur. It is noted that qualifying a forecast quality is somewhat independent of the data type. While the generated heuristic, time-slice size, and/or forecast model can be based upon a type of data being evaluated, the generation and/or application of a forecast quality metric is not. For instance, a variation value generated when comparing a number of calls in a time-slice to its associated forecast can be evaluated in a similar manner to a variation value generated when comparing a “call duration” metric to its associated forecasted value. Thus, these methods can be equally applicable to a variety of data types, such as data characterizing user actions/directions to a product and/or service, data characterizing technical and/or performance observations associated with a product and/or service, data characterizing how a user customizes or views a product and/or service, and so forth, provided a heuristic and forecast can be generated for the data.

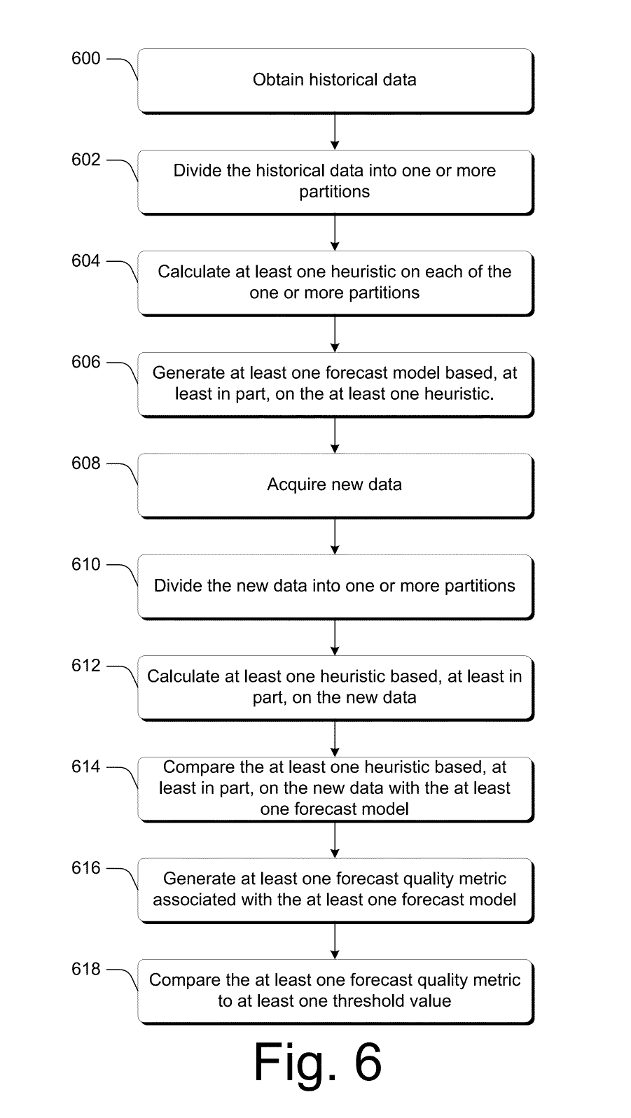

Consider now FIG. 6, which illustrates a flow diagram that describes steps in a method in accordance with one or more embodiments. The method can be implemented in connection with any suitable hardware, software, firmware or combination thereof. In at least some embodiments, aspects of the method can be implemented by a suitably configured software module, such as data heuristics engine module(s) 112 of FIGS. 1 and 2.

Step 600 obtains historical data. In some embodiments, the historical data represents data associated with events, interactions, and so forth, occurring in the past. As described above and below, the historical data can characterize and/or represent any suitable type of data types, and can be stored and represented in any suitable format. Further, the historical data can be obtained in any suitable way, such as through querying a data repository external to the querying computing device, querying data repository internal to the querying computing device, obtaining event log(s) from external servers, importing legaxy data, profiling custom data outside of a system, reprocessing old data for new heuristics, Extract, Transform, and Load (ETL) -ing a data warehouse for new information, “on-boarding” of new stream data that has old historical data, and so forth.

Responsive to obtaining the historical data, step 602 divides the historical data into one or more partitions, such as the time-slices discussed above. A partition size can be based upon any suitable characteristic associated with the data, and can be a fixed size from partition to partition, a variable size from partition to partition, or any other suitable combination. Responsive to dividing the historical data into partition(s), step 604 calculates at least one heuristic on each partition of the one or more partitions. Examples of how this can be done are provided above.

Step 606 generates at least one forecast model based, at least in part, on the heuristic or heuristics. For example, a forecasting model can be used to predict the behavior of a product and/or system over a 24-hour period based upon the heuristics calculated in step 604. In some embodiments, multiple forecast models can be generated (such as multiple 2 4-hour period forecasts using a same forecasting model for each one 24-hour forecast for a first day, one 24-hour forecast for a second day, etc.) and then averaged together. Once generated, some embodiments store the forecast model(s) in memory, such as model repository 312 of FIG. 3.

Step 608 acquires new data, such as incoming data 314 of FIG. 3. Any suitable type of data can be acquired, examples of which are provided above. Alternately or additionally, the new data can be represented in any suitable format, such as textual, binary, encoded, and so forth.

Responsive to acquiring new data, step 610 divides the new data into one or more partitions. The partition sizes can be fixed to a same size for each partition, vary in size from one another, or any combination thereof. The partition sizes can be determined in any suitable manner, examples of which are provided above.

Step 612 calculates at least one heuristic based, at least in part, on the new data. For example, some embodiments calculate at least one heuristic on each partition of a plurality of partitions associated with the new data. Responsive to calculating the at least one heuristic, step 614 compares the heuristic(s) based, at least in part on the new data, with the forecast model(s).

Step 616 generates at least one forecast quality metric associated with the forecast model(s). In some cases, the forecast quality metric can be based upon a comparison of the forecast(s) to incoming data, as further described above. However, it is to be appreciated and understood that any suitable forecast quality metric can be utilized without departing from the scope of the claimed subject matter.

Responsive to generating forecast quality metric, step 618 compares the forecast quality metric(s) to at least one threshold. The threshold can be configured to indicate acceptable and/unacceptable degrees of quality associated with the forecast. Responsive to the comparison indicating an acceptable degree of quality, some embodiments can update the model repository as described above. Alternately or additionally, responsive to the comparison indicating an unacceptable degree of quality, some embodiments can trigger a quality event and/or isolate the associated new data from the repository.

Having considered a discussion of qualifying data quality, consider now a discussion of an example device that can be utilized to implement the embodiments described above.

Example Device

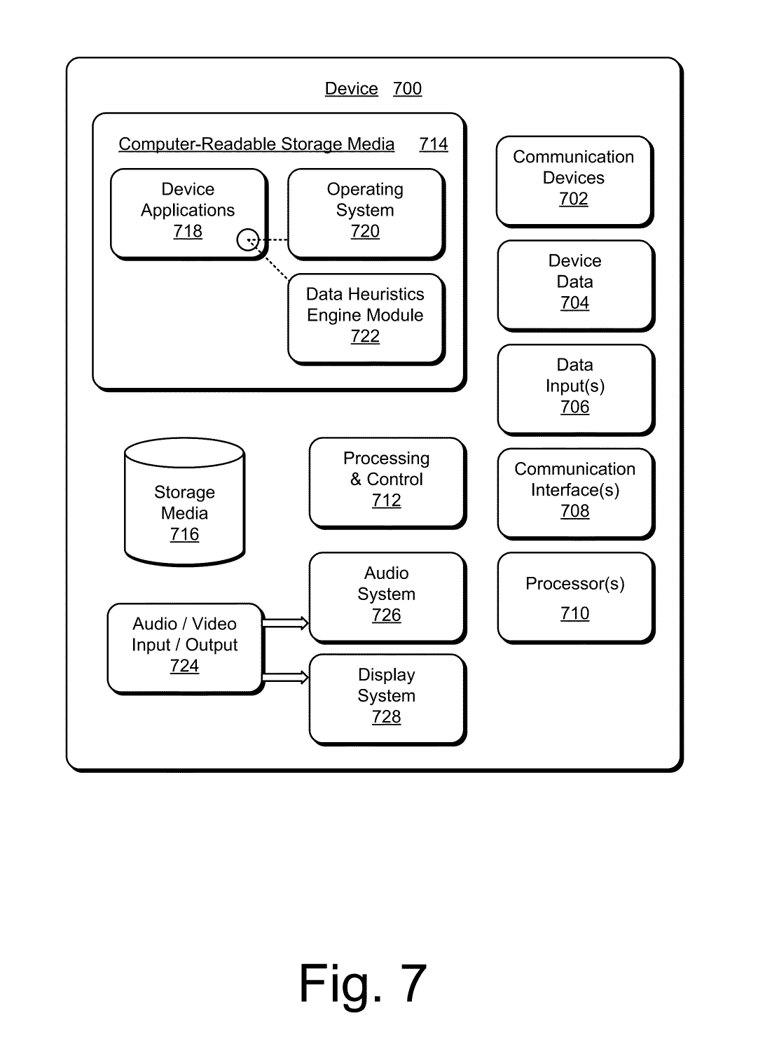

FIG. 7 illustrates various components of an example device 700 that can be implemented as any type of portable and/or computer device as described with reference to FIGS. 1 and 2 to implement embodiments of the data heuristics engine described herein. Device 700 includes communication devices 702 that enable wired and/or wireless communication of device data 704 (e.g., received data, data that is being received, data scheduled for broadcast, data packets of the data, etc.). The device data 704 or other device content can include configuration settings of the device, media content stored on the device, and/or information associated with a user of the device. Media content stored on device 700 can include any type of audio, video, and/or image data. Device 700 includes one or more data inputs 706 via which any type of data, media content, and/or inputs can be received, such as user-selectable inputs, messages, music, television media content, recorded video content, and any other type of audio, video, and/or image data received from any content and/or data source.

Device 700 also includes communication interfaces 708 that can be implemented as any one or more of a serial and/or parallel interface, a wireless interface, any type of network interface, a modem, and as any other type of communication interface. The communication interfaces 708 provide a connection and/or communication links between device 700 and a communication network by which other electronic, computing, and communication devices communicate data with device 700.

Device 700 includes one or more processors 710 (e.g., any of microprocessors, controllers, and the like) which process various computer-executable or readable instructions to control the operation of device 700 and to implement the embodiments described above. Alternatively or in addition, device 700 can be implemented with any one or combination of hardware, firmware, or fixed logic circuitry that is implemented in connection with processing and control circuits which are generally identified at 712. Although not shown, device 700 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 700 also includes computer-readable storage media 714, such as one or more memory components, examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 700 can also include a mass storage media device 716. Computer readable storage media is intended to refer to statutory forms of media. As such, computer readable storage media does not describe carrier waves or signals per se.

Computer-readable storage media 714 provides data storage mechanisms to store the device data 704, as well as various device applications 718 and any other types of information and/or data related to operational aspects of device 700. For example, an operating system 720 can be maintained as a computer application with the computer-readable storage media 714 and executed on processors 710. The device applications 718 can include a device manager (e.g., a control application, software application, signal processing and control module, code that is native to a particular device, a hardware abstraction layer for a particular device, etc.), as well as other applications that can include, web browsers, image processing applications, communication applications such as instant messaging applications, word processing applications and a variety of other different applications. The device applications 718 also include any system components or modules to implement embodiments of the techniques described herein. In this example, the device applications 718 include data heuristics engine module 722 that is shown as software modules and/or computer applications. Data heuristics engine module 722 is representative of software that is used to acquire historical and current data, generate heuristics and/or forecasts based upon the data, and additionally generate a forecast quality metric, as described above. Alternatively or in addition, data heuristics engine module 722 can be implemented as hardware, software, firmware, or any combination thereof.

Device 700 also includes an audio and/or video input-output system 724 that provides audio data to an audio system 726 and/or provides video data to a display system 728. The audio system 726 and/or the display system 728 can include any devices that process, display, and/or otherwise render audio, video, and image data. Video signals and audio signals can be communicated from device 700 to an audio device and/or to a display device via an RF (radio frequency) link, S-video link, composite video link, component video link, DVI (digital video interface), analog audio connection, or other similar communication link. In an embodiment, the audio system 726 and/or the display system 728 are implemented as external components to device 700. Alternatively, the audio system 726 and/or the display system 728 are implemented as integrated components of example device 700.

### CONCLUSION

Various embodiments generate at least one heuristic for a historical set of data. In some cases, the historical set of data can be divided into a plurality of partitions. Responsive to generating the heuristic(s) for the historical set of data, some embodiments generate at least one forecast based, at least in part on the heuristic(s) associated with the historical set of data. Alternately or additionally, heuristic(s) can be generated for an incoming set of data, and compared to the forecast(s) effective to determine one or more forecast quality metrics. Alternately or additionally some embodiments use the forecast quality metric(s) to prompt additional processing.

Although the embodiments have been described in language specific to structural features and/or methodological acts, it is to be understood that the embodiments defined in the appended claims are not necessarily limited to the specific features or acts described. Rather, the specific features and acts are disclosed as example forms of implementing the claimed embodiments.

What is claimed is:

1. A computer-implemented method comprising:
calculating at least one heuristic based on historical data associated with an object;
generating at least one forecast model based, at least in part, on the at least one heuristic based on the historical data;
acquiring new data associated with the object;
calculating at least one heuristic based, at least in part, on the new data;
comparing the at least one heuristic based, at least in part, on the new data with the at least one forecast model; and
generating at least one forecast quality metric associated with the at least one forecast model.

2. The method of claim 1, wherein calculating the at least one heuristic based on the historical data further comprises:
dividing the historical data into one or more partitions; and
calculating the at least one heuristic on each of the one or more partitions associated with the historical data.

3. The method of claim 2, wherein calculating the at least one heuristic based, at least in part, on the new data further comprises:
dividing the new data into one or more partitions; and
calculating the at least one heuristic on each of the one or more partitions associated with the new data.

4. The method of claim 3, wherein:
dividing the historical data into one or more partitions is based, at least in part, on at least one characteristic associated with the historical data; and
dividing the new data into one or more partitions is based, at least in part, on at least one characteristic associated with the new data.

5. The method of claim 4, wherein comparing the at least one heuristic based, at least in part, on the new data with the at least one forecast model further comprises comparing data generated from partitions having a same size

6. The method of claim 1, wherein the acquiring the new data further comprises acquiring the new data through real-time streaming data.

7. The method of claim 1 further comprising storing the at least one forecast model in a data repository.

8. The method of claim 1, wherein generating the at least one forecast quality metric further comprises generating a variance value.

9. One or more computer readable storage media embodying computer readable instructions which, when executed, implement a data heuristics engine comprising:
a time-slice module configured to:
obtain historical data associated with an object; and
divide the historical data in one or more partitions;
a heuristics calculation module configured to:
calculate at least one heuristic on each of the one or more partitions associated with the historical data;
a forecast generation module configured to:
generate at least one forecast model based on the at least one heuristic associated with the historical data; and
store the at least one forecast model in a data repository;
a time-slice counter module configured to:
divide incoming data associated with the object into one or more partitions; and
a quality scoring module configured to:
compare the incoming data with the at least one forecast model; and
generate a forecast quality metric configured to indicate an accuracy associated with the at least one forecast.

10. The one or more computer readable storage media of claim 9, wherein the quality scoring module is further configured to:
compare the forecast quality metric to a threshold effective to determine whether the forecast quality metric is above or below the threshold; and
responsive to determining the forecast quality metric is below the threshold, generate a quality event.

11. The one or more computer readable storage media of claim 10, wherein the quality scoring module is further configured to:
responsive to determining the forecast quality metric is below the threshold, isolate the incoming data associated with the forecast quality metric from the data repository.

12. The one or more computer readable storage media of claim 10, the data heuristics engine further comprising a model updater module configured to:
responsive to the quality scoring module determining the forecast quality metric is above the threshold, update the data repository with the incoming data associated with the forecast quality metric.

13. The one or more computer readable storage media of claim 12, wherein to update the data repository with the incoming data includes an ability to:
generate a new forecast model based, at least in part, on the incoming data; and
store the new forecast model in the data repository.

14. The one or more computer readable storage media of claim 13, wherein to store the new forecast model in the data repository includes an ability to average the new forecast model with at least one other forecast model stored in the data repository.

15. The one or more computer readable storage media of claim 9, wherein the time-slice module is further configured to divide the historical data based, at least in part, on characteristics associated with the historical data.

16. The one or more computer readable storage media of claim 9, wherein the time-slice counter module is further configured to divide the incoming data based, at least in part, on at least one of the at least one forecast models in the data repository.

17. A computer-implemented method comprising:
calculating at least one heuristic on each partition of a plurality of partitions associated with historical data characterizing an object;
calculating at least one heuristic on each partition of a plurality of partitions associated with new data characterizing the object;
generating at least one forecast quality metric based, at least in part, on a forecast model generated from the at least one heuristic associated with the historical data, and the at least one heuristic associated with the new data; and
comparing the at least one forecast quality metric to at least one threshold value effective to determine whether the forecast quality metric is above or below the threshold value.

18. The computer-implemented method of claim 17 further comprising:
responsive to determining the forecast quality metric is above the at least one threshold value, generating a forecast model based, at least in part on the new data associated with the forecast quality metric; and
responsive to generating the forecast model, storing the forecast model in a data repository.

19. The computer-implemented method of claim 18 further comprising:
responsive to determining the forecast quality metric is below the at least one threshold, generating a quality event; and
isolating the new data associated with the forecast quality metric from the data repository.

20. The computer-implemented method of claim 17, wherein partition sizes of the partitions associated with the historical data and the partitions associated with the new data are based, at least in part, upon time characteristics.
